(19) United States
(12) Patent Application Publication
(10) Pub. No.: US 2009/0310112 A1
(43) Pub. Date: Dec. 17, 2009

(54) EXPOSURE APPARATUS AND DEVICE MANUFACTURING METHOD

(75) Inventor: Tetsuji Kazaana, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/480,682

(22) Filed: Jun. 9, 2009

(30) Foreign Application Priority Data
Jun. 11, 2008 (JP) 2008-152577

(51) Int. Cl. G03B 27/54

(52) U.S. Cl. 355/67

(57) ABSTRACT

An exposure apparatus which has an illumination unit SL illuminating a reticle R and is configured to illuminate a part of the reticle R in an illumination area adjusted by the illumination unit SL to expose a wafer W while the reticle R and the wafer W are scanned, the exposure apparatus comprising a control apparatus 28 configured to determine whether or not the whole chip area is included inside a valid area based on information of an outer edge of the valid area set with respect to the wafer W, information of a shot area set with respect to the wafer W, and information of a chip area set inside the shot area, and configured to stop the illumination unit SL so that the whole chip area is not exposed when the whole chip area is not included inside the valid area.

### BACKGROUND OF THE INVENTION

1. Field of the Invention

The present invention relates to an exposure apparatus, and more particularly to an exposure apparatus which efficiently irradiates exposure light.

2. Description of the Related Art

In a photolithography process at the time of manufacturing a device such as a semiconductor device, a circuit pattern formed on a reticle (original plate) is exposed onto a wafer (substrate) coated with a photosensitizing agent. As an exposure method, differently from a conventional one-shot exposure type apparatus called stepper, a scanning exposure type method of a step-and-scan method which synchronously controls the reticle and the wafer to scan them becomes mainstream.

A scanning type exposure apparatus performs a step movement of the wafer stage which holds the wafer to a starting position of the scanning exposure for the exposure of each shot. Furthermore, it starts to accelerate from the position and the relative position between the reticle stage and the wafer stage is synchronously controlled to be stabilized.

Subsequently, in a section where an illumination field is overlapped on a rectangular shot area, the irradiation of exposure light is performed while scanning both stages at a predetermined velocity. After scanning by a shot size in a scanning direction, the irradiation of the exposure apparatus is stopped and the movement for the starting position with respect to the next shot exposure is performed in a scanning direction. The deceleration is started to reverse the scanning direction, and at the same time the step movement is performed with respect to the non-scanning direction.

An outer shape of the wafer is a circle while the shot area exposed onto the wafer by scanning is a rectangular. Therefore, the shot arranged around the circle outer circumference of the wafer is a shot including an area outside the wafer (hereinafter referred to as a “partial shot”). With respect to the exposure for the outer circumference of the wafer, for suppressing the polishing unevenness of CMP (Chemical Mechanical Polishing), the exposure is generally performed as usual in order to stabilize the exposure accuracy for the inner shot.

On the other hand, in accordance with the miniaturization of the exposure line width, conventional KrF (krypton fluoride) laser has been replaced by ArF (argon fluoride) laser which is currently mainstream. However, ArF laser is expensive. Therefore, there is also a problem that the influence on the production cost caused by a wasted irradiation can not be ignored. In other words, in accordance with a device or a layer to be processed, the cost may be more important than the exposure stability, and a function that reduces the unnecessary laser irradiation is required.

Japanese Patent Laid-Open No. H9-293656 proposes a method of improving throughput by skipping the exposure motion for a partial shot positioned at top and bottom of the wafer. Because this method narrows the exposure section for the partial shot, a subsidiary effect that the wasted irradiation is reduced can also be expected.

However, as disclosed in Japanese Patent Laid-Open No. 2001-230170, when a step movement from a previous shot to the next shot involves a line feed motion, the improvement of the throughput can not be necessarily expected. It is because when the scanning direction is reversed after scanning a necessary distance in order to accelerate and stabilize a wafer stage before the scanning exposure for the next shot, scanning the adjustment distance for the next shot exposure at a constant velocity similar to the velocity at the time of exposure without decelerating synchronously with a normal shot area is more efficient.

### BRIEF SUMMARY OF THE INVENTION

The present invention provides an exposure apparatus which enables the efficient irradiation of exposure light. The present invention also provides a device manufacturing method using the exposure apparatus.

An exposure apparatus as one aspect of the present invention has an illumination unit illuminating an original plate and is configured to illuminate a part of the original plate in an illumination area adjusted by the illumination unit to expose a substrate while the original plate and the substrate is scanned. The exposure apparatus includes a controller configured to determine whether or not a whole chip area is included inside a valid area based on information of an outer edge of the valid area set with respect to the substrate, information of a shot area set with respect to the substrate, and information of a chip area set inside the shot area, and configured to stop irradiation of exposure light by the illumination unit so that the whole chip area is not exposed when the whole chip area is not included inside the valid area.

A device manufacturing method as another aspect of the present invention includes the steps of exposing a substrate using an exposure apparatus and developing the exposed substrate.

Further features and aspects of the present invention will become apparent from the following description of exemplary embodiments with reference to the attached drawings.

### BRIEF DESCRIPTION OF THE DRAWINGS

FIG. 1 is a schematic configuration diagram of a projection exposure apparatus in the present embodiment.

FIG. 2 is a view showing an exposure area and a non-exposure area of a partial shot in embodiment 1.

FIG. 3 is a view showing an exposure area and a non-exposure area of a partial shot in embodiment 2.

FIG. 4 is a view showing an exposure area and a non-exposure area of a partial shot in embodiment 3.

FIG. 5 is one example of a layout where a plurality of chips are provided in a shot in embodiment 3.

### DETAILED DESCRIPTION OF THE PREFERRED EMBODIMENTS

Exemplary embodiments of the present invention will be described below with reference to the accompanied drawings. In each of the drawings, the same elements will be denoted by the same reference numerals and the descriptions thereof will be omitted.

The embodiment of the present invention is a scanning exposure apparatus which is used for exposing a pattern on a reticle onto a wafer coated with a photosensitizing agent in a photolithography process for manufacturing a semiconductor device, a liquid crystal device, or the like and a device manufacturing method using the scanning exposure apparatus. In particular, in the present embodiment, a step-and scan type scanning exposure apparatus that sequentially transfers a circuit pattern on the reticle onto each shot area on the wafer while the reticle and the wafer are synchronously scanned in a state where a part of the pattern on the reticle is projected onto the wafer will be described.

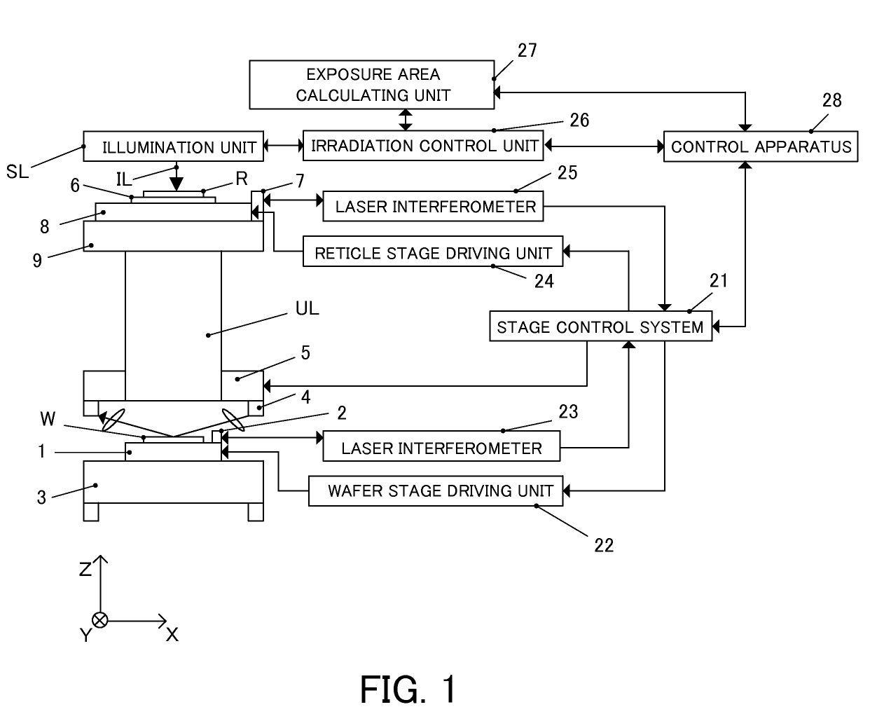

First, a configuration of a projection exposure apparatus in the embodiment of present invention will be described. FIG. 1 is a schematic configuration diagram of a projection exposure apparatus in the present embodiment. The exposure apparatus of FIG. 1 includes an illumination unit SL which illuminates a reticle (an original plate), and exposes the wafer by illuminating a part of the reticle in an illumination area adjusted by the illumination unit SL while scanning the reticle and the wafer (substrate).

In FIG. 1, the illumination unit SL includes an exposure light source which performs a formation of exposure light in accordance with a homogenization of an illuminance and an illumination mode and a masking connection unit which forms exposure light having a constant illuminance distribution. The illumination unit SL includes a pulling unit which introduces laser light from a laser unit of an exposure light source such as ArF, and an optical axis adjusting unit.

Illumination light IL (exposure light) emitted from the illumination unit SL illuminates an illumination area having a shape like a slit on a reticle R with a uniform illuminance distribution. When the pattern in the illumination area on the reticle R is reversely reduced with a projection magnification α(for example, α=1/4) by a projection optical system UL, the projection image is exposed on an illumination field having a shape like a slit on the wafer W. For example, KrF excimer laser light, ArF excimer laser light, or ultraviolet emission line of an ultrahigh-pressure mercury lamp (g-line, i-line) is used as illumination light IL. The present embodiment is not limited to this, but other illumination lights can also be used.

In the following description, Z-axis is defined in parallel to an optical axis of the illumination light IL, and an axis parallel to a paper plane is defined as X-axis and an axis vertical to the paper plane is defined as Y-axis in a plane vertical to the optical axis. The reticle R is disposed on a reticle stage 6. The reticle stage 6 scans synchronously with a wafer stage 1 (a substrate stage) in addition to perform a two-dimensional micromotion in a plane vertical to the optical axis of the projection optical system UL to position the reticle R. Furthermore, the reticle stage 6 has a stroke so that a whole surface of the pattern area of the reticle R can cross at least the illumination area in a scanning axis direction.

A bar mirror 7 which reflects a laser beam from an external laser interferometer 25 is fixed on an edge part of the reticle stage 6. The position of the reticle stage 6 is always monitored by the laser interferometer 25. The position information of the reticle stage 6 obtained by the laser interferometer 25 is supplied to a stage control system 21. The stage control system 21 controls the position and the velocity of the reticle stage 6 via a reticle stage driving unit 24 based on the position information.

On the other hand, the wafer W is disposed on a suction plate provided on the wafer stage 1. The wafer stage 1 moves while supporting the wafer W. The use of the wafer stage 1 enables a step-and-scan motion that repeats a scanning motion for each shot area on the wafer W. The movement in a Z direction or in a tilt direction is performed by the stage control system 21 controlling the wafer stage 1.

A bar mirror 2 is provided on an edge part of the wafer stage 1 in order to reflect the laser beam from a laser interferometer 23. The position of the wafer stage 1 is always monitored by the laser interferometer 23. Similarly to the control of the reticle stage 6, the position and the velocity of the wafer stage 1 is controlled by the stage control system 21 via a wafer stage driving unit 22 based on the position information.

A control apparatus 28 integrally controls each of motions of an irradiation control unit 26, an exposure area calculating unit 27, and a stage control system 21. The irradiation control unit 26 controls the motion of the illumination unit SL based on a command from the control apparatus 28, for example it stops irradiating the exposure light from the illumination unit SL. The exposure area calculating unit 27 calculates an exposure area based on a command from the control apparatus 28 as described in each of the following embodiments. The stage control system 21 controls the motions of the wafer stage driving unit 22 and the reticle stage driving unit 24 based on a command from the control apparatus 28 and signals from the laser interferometers 23 and 25. The control apparatus 28, the irradiation control unit 26, and the stage control system 21 constitute a controller which controls the exposure apparatus.

In FIG. 1, reference numeral 3 denotes a wafer stage platen, reference numeral 4 denotes a multipoint AF sensor, reference numeral 5 denotes an optical barrel platen, reference numeral 8 denotes a reticle stage guide, and reference numeral 9 denotes an outer barrel.

At the time of scanning exposure, the reticle R is scanned in a +Y direction, for example at a velocity Vr. In synchronization with the reticle R, the wafer W is scanned in a −Y direction at a velocity Vw. The ratio of the scanning velocities Vw and Vr (Vw/Vr) exactly coincides with the projection magnification a from the reticle R to the wafer W of the projection optical system UL. Thus, the pattern having a shape like a slit on the reticle R is projected by the illumination light IL, and as a result, the pattern is exactly transferred onto each shot area of the wafer W.

### Embodiment 1

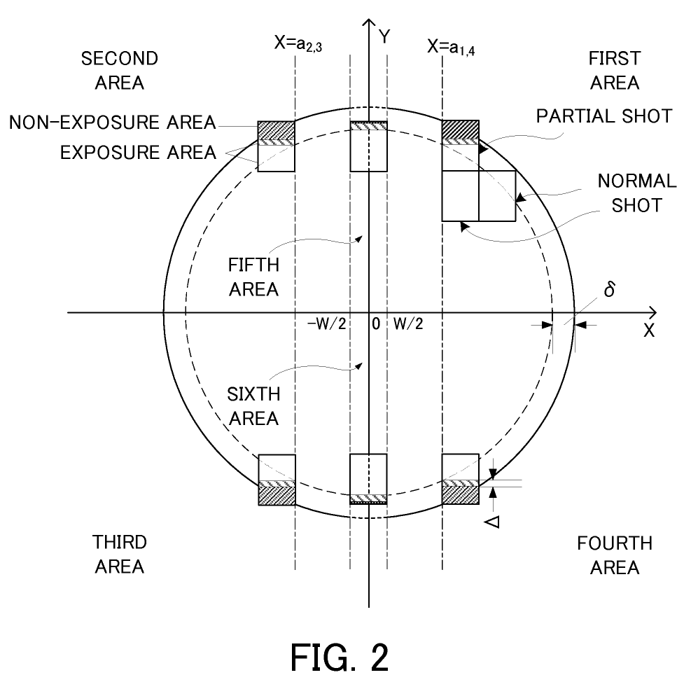

Next, with regard to embodiment 1 of the present invention, a method of setting an exposure area in a partial shot will be described. FIG. 2 is a view showing an exposure area and a non-exposure area of a partial shot in embodiment 1.

The partial shot is a shot at a position across the outer circumference of the wafer, and an area where the exposure is not partially necessary is included in the shot area. Specifically, the partial shot is a shot that includes a rectangular area having the same length as a shot size X outside the wafer with respect to a non-scanning direction (X-axis direction), and it has a non-exposure area (area indicated by diagonal lines) in a scanning direction (Y-axis direction). Therefore, at the time that the exposure slit is disposed in the shot area, the irradiation of the exposure light can be stopped.

As shown in FIG. 2, the rectangular partial shot includes a non-exposure area indicated by diagonal lines. An exposure area indicated by diagonal lines between the non-exposure area and the exposure area is a range of an exposure error Δ at the time of exposure as described later.

In the exposure area in the present embodiment, even if a part of the exposure area is an area outside the wafer, an area needed to be exposed with respect to a scanning direction exists on the whole surface of the shot area when the area is not a rectangular shape. Therefore, the area is treated as an exposure area where a normal exposure is performed.

The exposure rectangular area of the partial shot is calculated by the exposure area calculating unit 27 based on a command of the control apparatus 28. The exposure area calculating unit 27 calculates the exposure area based on an outer circumference circle of the wafer or an arbitrary concentric circle whose radius length is smaller than that of the outer circumference circle of the wafer and the position of each shot. In the embodiment, whether or not the non-exposure area exists is determined every shot, and the corresponding exposure area needs to be calculated when the non-exposure area exists.

A wafer area is represented as X²+Y²=r² in a wafer coordinate system XY corresponding to the XY axis described above, where r is a radius of the wafer size. When the wafer has a size of 8 inch, r is equal to 100 [mm], and when the wafer has a size of 12 inch, r is equal to 150 [mm].

When a variable margin δ is provided with respect to the wafer radius r, the wafer area (valid area) is represented by the following expression (1). The wafer area (valid area) in the case of setting δ corresponds to an inner area of a concentric circle whose radius is smaller than that of the wafer.

X²+Y²=(r−δ)² (1)

δ is an arbitrary value of the range of 0<δ<r. The value of δ is set on the operation display provided at the control apparatus 28 or based on the online information from a host server such as a central control server. An invalid area which has a width of around 2 to 3 mm can be set for δ. Considering the radius error of the wafer or the like, a difference distance between the area which is surely to be exposed and the outer circumference of the wafer can also be set.

The non-exposure area is calculated for the wafer area (valid area) represented by expression (1) every shot. As a calculating procedure, first, information of each shot area including a shot size (w, h) and a central coordinate (x, y) of each shot in the wafer coordinate system XY is obtained.

Based on the information of the shot area and the information of the above valid area (wafer area), the control apparatus 28 determines whether or not each shot corresponds to the partial shot, i.e. whether or not the non-exposure area exists. Specifically, coordinate values (information of a shot area) of four corners (four edge points) of the shot area are calculated based on the shot size and the central coordinate of the shot.

As shown in FIG. 2, when at least three corners of the shot area are included inside the valid area (wafer area), the control apparatus 28 treats this shot as a normal shot and determines that a non-exposure area does not exist. On the other hand, when only two corners of the shot area are included inside the valid area at a maximum, the control apparatus 28 treats this shot as a partial shot and determines that a non-exposure area exists.

When the control apparatus 28 determines that the shot is a partial shot, it obtains an intersection of a corresponding axis X=a every shot area and the valid area (wafer area). The non-exposure area is calculated from the coordinate value of the intersection and the shot size and the central coordinate of the shot.

In this case, in accordance with the following first to sixth areas, the vertical axis X=a which determines the shot area (rectangular area) is defined. In the embodiment, the first area is in a range of X>w/2 and Y≧0, the second area is in a range of X<−w/2 and Y≧0, the third area is in a range of X<−w/2 and Y<0, the fourth area is in a range of X>w/2 and Y<0, the fifth area is in a range of −w/2<X<w/2 and Y≧0, and the sixth are in a range of −w/2<X<w/2 and Y<0.

The first area and the fourth area are defined by a=x−w/2 that is a left vertical axis of the shot area. The second area and the third area are defined by a=x+w/2 that is a right vertical axis of the shot area. The fifth area and the sixth area are defined by a=0 that is a Y-axis.

Subsequently, when obtaining the intersection of the vertical axis X=a and the circle represented by expression (1), the following expression (2) is obtained. The sign of expression (2) is determined which of the first to sixth areas the shot area exists.

Y=±sqrt((r−δ)²−a²) (2)

Thus, the non-exposure area P1′ (four corners) of each of the first to sixth areas is represented as follows. In the embodiment, the following non-exposure area P1′ is shown in a clockwise direction from the lower left in the XY plane.

In the first area, P1′ is represented as P1′={(x−w/2, sqrt((r−δ)²−(x−w/2)²), (x−w/2, y+h/2), (x+w/2, y+h/2), (x+w/2, sqrt((r−δ)²−(x−w/2)²))}.

In the second area, P1′ is represented as P1′={(x−w/2, sqrt((r−δ)²−(x+w/2)²)), (x−w/2, y+h/2), (x+w/2, y+h/2), (x+w/2, sqrt((r−δ)²−(x+w/2)²))}.

In the third area, P1′ is represented as P1′={(x−w/2, y−h/2)), (x−w/2, −sqrt((r−δ)2−(x+w/2)2)), (x+w/2, −sqrt((r−δ)2−(x+w/2)2)), (x+w/2,y−h/2)}.

In the fourth area, P1′ is represented as P1′={(x−w/2, y−h/2)), (x−w/2, −sqrt((r−δ)²−(x−w/2)²)), (x+w/2, −sqrt((r−δ)²−(x−w/2)²)), (x+w/2,y−h/2)}.

In the fifth area, P1′ is represented as P1′={(x−w/2, r−δ), (x−w/2, y+h/2), (x+w/2, y+h/2), (x+w/2, r−δ)}

In the sixth area, P1′ is represented as P1′={(x−w/2, y−h/2), (x−w/2, −(r−δ)), (x+w/2, −(r−δ)), (x+w/2, y−h/2)}.

Each corner P1 of the every exposure area where an exposure error Δ in an arbitrary scanning direction is added with respect to the non-exposure area P1′ is represented as follows. Similarly to the above description, each corner is shown in a clockwise direction from the lower left in the XY plane.

In the first area, P1 is represented as P1={(x−w/2, y−h/2)), (x−w/2, sqrt((r−δ)²−(x−w/2)²)+Δ), (x+w/2, sqrt((r−δ)²−(x−w/2)²)+Δ), (x+w/2, y−h/2)}.

In the second area, P1 is represented as P1={(x−w/2, y−h/2)), (x−w/2, sqrt((r−δ)²−(x+w/2)²)+Δ), (x+w/2, sqrt((r−δ)²−(x+w/2)²)+Δ), (x+w/2,y−h/2)}.

In the third area, P1 is represented as P1={(x−w/2, −sqrt((r−δ)²−(x+w/2)²)−Δ), (x−w/2, y+h/2), (x+w/2, y+h/2), (x+w/2, −sqrt((r−δ)²−(x+w/2)²)−Δ)}.

In the fourth area, P1 is represented as P1={(x−w/2, −sqrt((r−δ)²−(x−w/2)²)−Δ), (x−w/2, y+h/2), (x+w/2, y+h/2), (x+w/2, −sqrt((r−δ)²−(x−w/2)²)−Δ)}.

In the fifth area, P1 is represented as P1={(x−w/2, y−h/2), (x−w/2, r−δ+Δ), (x+w/2, r−δ+Δ), (x+w/2, y−h/2)}.

In the sixth area, P1 is represented as P1={(x−w/2, −(r−δ)−Δ), (x−w/2, y+h/2), (x+w/2, y+h/2), (x+w/2, −(r−δ)−Δ)}.

The exposure error Δ for the scanning direction such as masking is set on the operation display provided at the control apparatus 28 or based on the online information from a host server such as a central control server in accordance with the exposure performance.

In FIG. 2 and the expression described above, the exposure error Δ is set in a direction where Y is positive when Y>0, on the other hand, it is set in a direction where Y is negative when Y<0. The embodiment is not limited to this, but the exposure error Δ can be set in one of positive and negative directions in all areas. When the error in a scanning direction is added to a radiation direction (δ), the coordinate in the radiation direction is represented by sqrt((r+Δ)²−a²) and the coordinate in the scanning direction is represented by sqrt(r²−a²)+Δ. When expanding both coordinates and deleting common terms to compare them, an extra non-exposure area is made because the coordinate in the radiation direction is greater.

In the above embodiment, assuming the case where the shots do not have a layout like a lattice, the calculation is performed for every shot. However, ordinarily, the shots are arranged like a grid, and in many cases, the shots have a symmetry such as a line symmetry in the wafer coordinate system. Therefore, for example, the fact that partial shots positioned symmetric with respect to the XY axis are the same exposure area can be used. When using the symmetry to determine the necessity of the calculation, the calculation of the exposure area and the non-exposure area can be simplified.

When calculating the exposure area, the irradiation reduction ratio of the exposure light can be obtained from the ratio (S′/S) of the sum S′ of the exposure areas in partial shots for the whole wafer surface and the sum S of the shot areas existing on the layout. The control apparatus 28 calculates the irradiation reduction ratio of the exposure light reduced by controlling the illumination unit SL. The irradiation reduction ratio is displayed on the operation display of the control apparatus 28 as a result of the irradiation reduction of the exposure light or is informed by the online information from a host server such as a central control server. The irradiation reduction ratio is, for example, used for a life management of the light source.

The exposure area of the partial shot is calculated by the exposure area calculating unit 27 at the time that the shot layout is fixed on a recipe or the above non-exposure area parameter is fixed. At the time of scanning exposure, the irradiation control unit 26 controls the illumination unit SL so as to stop the illumination light IL (exposure light) in a condition previously obtained as described above.

The control apparatus 28 obtains information of an outer edge of the valid area set with respect to the wafer and information of the shot area set with respect to the wafer. The control apparatus 28 determines whether or not it is a non-exposure area based on the information. When the control apparatus 28 determines that it is the non-exposure area, it stops the irradiation of the exposure light by the illumination unit SL. The control apparatus 28 previously determines the exposure area based on the information of the outer edge of the valid area and the information of the shot area before exposing the wafer W.

The stage control system 21 synchronously controls the acceleration, constant velocity, or deceleration of the wafer stage 1 and the reticle stage 6 at the time of exposure process. In a normal exposure area, the exposure light is irradiated when the wafer stage 1 and the reticle stage 6 are controlled to be a constant velocity. However, the control apparatus 28 stops the irradiation of the exposure light independently from the scanning control of the wafer stage 1 and the reticle stage 6 in the non-exposure area. More specifically, the control apparatus 28 stops the irradiation of the exposure light by the illumination unit SL before the deceleration of the wafer stage 1 in the non-exposure area. Such a control enables the reduction of the cost caused by the wasted irradiation of the exposure light without decreasing the throughput.

The method of calculating the exposure area in the present embodiment is a method of exposing all of rectangular areas inside the specified circle outer circumference considering the margin δ and the exposure error Δ in a scanning direction for the partial shot. Therefore, when the exposure area is defined for the wafer outer circumference without setting δ, a part where the exposure process is not performed does not exist on the wafer. Accordingly, the irradiation of the exposure light can be reduced without influencing the exposure performance.

### Embodiment 2

Next, embodiment 2 of the present invention will be described. The present embodiment is a method of performing a partial shot to further reduce exposure light compared with embodiment 1. The configuration of a scanning exposure apparatus of the present embodiment is the same as that of embodiment 1 and other descriptions which are the same as those of embodiment 1 will be omitted.

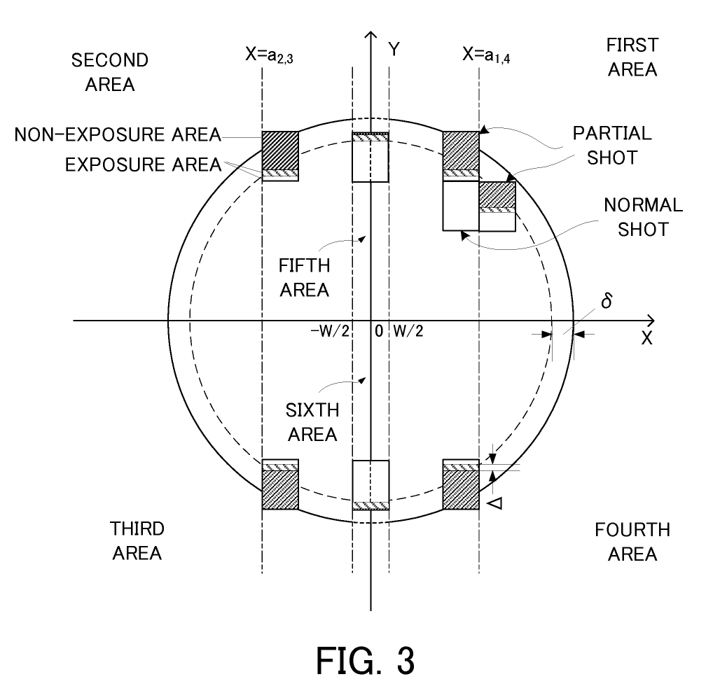

FIG. 3 is a view showing an exposure area and a non-exposure area of a partial shot in embodiment 2. In embodiment 1, the rectangular area which is positioned outside the wafer outer circumference or the concentric circle (valid area) whose radius length is smaller than that of the wafer outer circumference has been set as a non-exposure area. On the other hand, in the present embodiment, the rectangular area existing completely inside the valid area is set as an exposure area, and others are set as a non-exposure area.

The way of thinking as to the wafer area is the same as that of embodiment 1, and the circle represented by expression (1) is defined as an outer circumference. The present embodiment is the same as embodiment 1 in that whether or not each shot corresponds to a partial shot, i.e. whether or not a non-exposure area exists, is obtained from the relation of the shot size (w, h), the central coordinate (x, y) of each shot in the wafer coordinate system, and the circle represented by expression (1).

However, the exposure apparatus of the present embodiment, as shown in FIG. 3, determines that the shot is a normal shot (there is no non-exposure area) if all four corners exist inside the circle based on the position relation of the coordinate of the four corners of the shot area and the circle represented by expression (1). On the other hand, if there are only three corners or less among four corners inside the circle, the shot is determined as a partial shot (there is a non-exposure area).

When each shot is a partial shot, the intersection of the corresponding axis X=a and the circle represented by expression (1) is obtained every shot area. The non-exposure area is calculated from the coordinate of the intersection and the shot size and the central coordinate of the shot. In this case, the vertical axis X=a which determines the rectangular area is defined for the first to sixth area independently in accordance with the position where the central coordinate of each shot exists in the wafer coordinate system as follows.

When the central coordinate of each shot exists in the first area or the fourth area, the rectangular shot area is defined as a=x+w/2 that is a right vertical axis of the shot area. When the central coordinate of each shot exists in the second area or the third area, the rectangular shot area is defined as a=x−w/2 that is a left vertical axis of the shot area. The central coordinate of each shot exists in the fifth area or the sixth area, the rectangular shot area is defined as a=0.

Intersection of the vertical axis X=a and the circle represented by expression (1) is the same as that of embodiment 1, and is represented by expression (2). The sign of the right side in expression (2) is determined by the position where the central coordinate of the shot exists in the first to sixth areas. Using expression (2), each corner P2′ of the non-exposure rectangular area shown independently from each of the first to sixth areas is represented as follow. In this case, each corner is shown in a clockwise direction from the lower left in the XY plane.

In the first area, P2′ is represented as P2′={(x−w/2, sqrt((r−δ)²−(x+w/2)²)), (x−w/2, y+h/2), (x+w/2, y+h/2), (x+w/2, sqrt((r−δ)²−(x+w/2)²))}.

In the second area, P2′ is represented as P2′={(x−w/2, sqrt((r−δ)²−(x−w/2)²)), (x−w/2, y+h/2), (x+w/2, y+h/2), (x+w/2, sqrt((r−δ)²−(x−w/2)²))}.

In the third area, P2′ is represented as P2′={(x−w/2, y−h/2)), (x−w/2, −sqrt((r−δ)²−(x−w/2)²)) (x+w/2, −sqrt((r−δ)²−(x−w/2)²)), (x+w/2,y−h/2)}.

In the fourth area, P2′ is represented as P2′={(x−w/2, y−h/2)), (x−w/2, −sqrt((r−δ)²−(x+w/2)²)) (x+w/2, −sqrt((r−δ)²−(x+w/2)²)), (x+w/2,y−h/2)}.

In the fifth area, P2′ is represented as P2′={(x−w/2, r−δ), (x−w/2, y+h/2), (x+w/2, y+h/2), (x+w/2, r−δ)}.

In the sixth area, P2′ is represented as P2′={(x−w/2, y−h/2), (x−w/2, −(r−δ)), (x+w/2, −(r−δ), (x+w/2, y−h/2)}.

Each corner P2 of every exposure area in the first to sixth areas where an exposure error Δ in an arbitrary scanning direction is added with respect to the non-exposure area P2′ is represented as follows. In this case, similarly to the above description, each corner is shown in a clockwise direction from the lower left in the XY plane.

In the first area, P2 is represented as 2={(x−w/2,y−h/2)),(x−w/2, sqrt((r−δ)²−(x+w/2)²)+Δ) (x+w/2, sqrt((r−δ)²−(x+w/2)²)+Δ), (x+w/2,y−h/2)}.

In the second area, P2 is represented as P2={(x−w/2, y−h/2)), (x−w/2, sqrt((r−δ)²−(x−w/2) 2)+Δ), (x+w/2, sqrt((r−δ)²−(x−w/2)²)+Δ), (x+w/2,y−h/2)}.

In the third area, P2 is represented as P2={(x−w/2, −sqrt((r−δ)²−(x−w/2)²)−Δ), (x−w/2, y+h/2), (x+w/2, y+h/2), (x+w/2, −sqrt((r−δ)²−(x−w/2)²)−Δ)}.

In the fourth area, P2 is represented as P2={(x−w/2, −sqrt((r−δ)²−(x+w/2)²)−Δ), (x−w/2, y+h/2), (x+w/2, y+h/2), (x+w/2, −sqrt((r−δ)²−(x+w/2)²)−Δ)}.

In the fifth area, P2 is represented as P2={(x−w/2, y−h/2)), (x−w/2, r−δ+Δ), (x+w/2, r−δ+Δ), (x+w/2, y−h/2)}.

In the sixth area, P2 is represented as P2={(x−w/2, −(r−δ)−Δ), (x−w/2, y+h/2), (x+w/2, y+h/2), (x+w/2, −(r−δ)−Δ)}.

Similarly to embodiment 1, the control apparatus 28 obtains the information of the outer edge of the valid area set for the wafer and the information of the shot area set for the wafer. The control apparatus 28 determines whether or not it is a non-exposure area based on the information and stops the irradiation of the exposure light by the illumination unit SL if the control apparatus 28 determines that it is the non-exposure area. The control apparatus 28 previously determines the exposure area based on the information of the outer edge of the valid area and the information of the shot area before exposing the wafer W.

The present embodiment treats only the exposable rectangular area inside the circle outer circumference specified in the partial shot as an exposure area. Therefore, according to the exposure apparatus of the present embodiment, the irradiation reduction ratio of the exposure light can be improved compared to the case of embodiment 1.

However, in the present embodiment, because the non-exposure area is provided inside the specified circle outer circumference, a part without exposure is generated at the circumference of the wafer, and as a result, there is a possibility to influence the exposure performance. In this case, if the part without exposure is processed by a peripheral exposure apparatus, the throughput or the exposure performance is not influenced and the irradiation cost can be reduced because an expensive light source is not used.

On the other hand, outside the wafer (valid area), the exposure light is not irradiated. Therefore, a photo sensitive member such as a wafer stage 1 shown in FIG. 1, a measurement mark provided on a wafer stage platen 3, a plate (not shown) for filling liquid outside the wafer in an immersion exposure apparatus, or the like is not influenced. When each shot is a partial shot, in order to further improve the irradiation reduction ratio, the method that the exposure process of the shot itself is not performed can also be adopted.

### Embodiment 3

Next, embodiment 3 of the present invention will be described.

An exposure apparatus of the present invention efficiently irradiates exposure light when a plurality of chip areas exist inside a shot. In the present embodiment, particularly, the exposure area is expanded by the size of the chip area for a non-exposure area on a partial shot when a part of an exposable rectangular chip area exists. The configuration of the scanning exposure apparatus in the present embodiment is the same as that of embodiment 1 and other descriptions which are the same as those of embodiment 1 will be omitted.

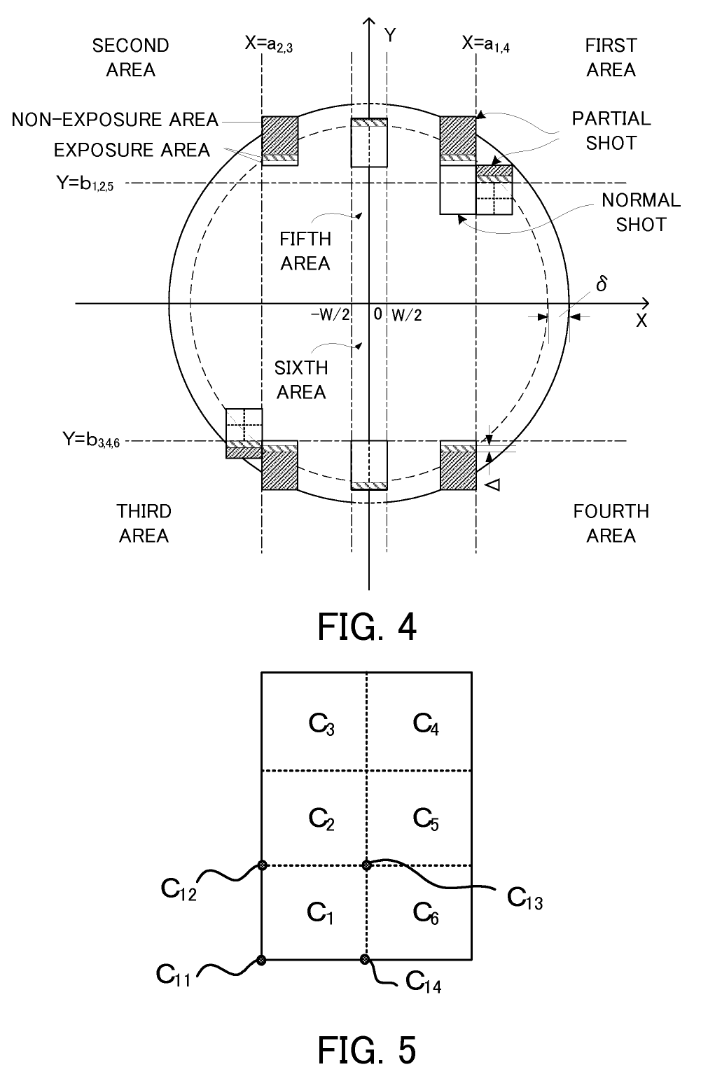

FIG. 4 is a view showing an exposure area and a non-exposure area of a partial shot in embodiment 3. FIG. 5 is one example of a layout where a plurality of chips exist in a shot in embodiment 3.

In the present embodiment, first, the coordinate value Cᵢⱼ (x, y) of each chip area converted into the wafer coordinate system XY is obtained based on the position information of a plurality of chip areas of a pattern formed on the reticle. In the embodiment, reference sign i is an index that represents each chip area existing in the reticle (in the shot area), and the range of 1≦i≦n (n: the number of chip areas existing in the pattern of the reticle) is satisfied. As shown in FIG. 5, since the number of the chip areas in the present embodiment is six, the range of i is 1≦i≦6. Reference sign j is an index that represents an edge point in each rectangular chip area, and the range of 1≦i≦4 is satisfied.

When the information of each chip area set inside the shot area (coordinate value Cᵢⱼ (x, y)) is obtained, subsequently for the coordinate value Cᵢⱼ (x, y), it is determined whether or not the four points that is edge points in each rectangular chip area are included in the non-exposure area P2′ obtained in embodiment 2.

When the number of the edge points included inside the non-exposure area P2′ is equal to or less than three among the coordinate value Cᵢⱼ (x, y) (four edge points) of each chip area, the chip area can not be exposed even if the exposure area is expanded. Therefore, when the number of the edge points included inside the non-exposure area P2′ is equal to or less than three for all chip areas inside the shot area, other chip areas can not be exposed even if the exposure area is expanded from the non-exposure area P2′. In this case, the exposure area is not expanded from among the non-exposure area P2′.

On the other hand, when a chip area in which all four points that is edge points are included in the non-exposure area P2′ exists among a plurality of chip areas inside the shot area, the exposure area is expanded from among the non-exposure area P2′. When at least one of the chip areas Cᵢ is completely included in the non-exposure area P2′, the exposure area is expanded based on the coordinate value Cᵢⱼ (x, y) of the chip area completely included in the non-exposure area P2′. The exposure area is determined in accordance with the position where the central coordinate of the shot area exists in the wafer coordinate system XY. Specifically, it is determined every area (first to sixth areas) in the wafer coordinate system XY, and a boundary axis of the non-exposure area is defined as Y=b.

In the present embodiment, when the central coordinate of the shot area is positioned in the first, second or fifth area, the maximum Y coordinate value among the coordinate values Cᵢⱼ (x, y) of the chip area completely included in the non-exposure area P2′ is defined as b. When the central coordinate of the shot area is positioned in the third, fourth or sixth area, the minimum Y coordinate value among the coordinate values Cᵢⱼ (x, y) of the chip area completely included in the non-exposure area P2′ is defined as b.

The use of the boundary axis Y=b of the non-exposure area set as described above enables each coordinate P3′ of the non-exposure area for each of the first to sixth areas to be represented as follows. In the embodiment, each corner is shown in a clockwise direction from the lower left in the XY plane.

In the first, second, or fifth area, the non-exposure area P3′ is represented as P3′={(x−w/2, b), (x−w/2, y+h/2), (x+w/2, y+h/2), (x+w/2, b)}.

In the third, fourth, or the sixth area, the non-exposure area P3′ is represented as P3′={(x−w/2, y−h/2), (x−w/2, b), (x+w/2, b), (x+w/2, y−h/2)}.

Each corner of the exposure area P3 where an error Δ in an arbitrary scanning direction is added with respect to the non-exposure area P3′ is represented as follows. In the embodiment, each corner is shown in a clockwise direction from the lower left in the XY plane.

In the first, second, or fifth area, the exposure area P3 is represented as P3={(x−w/2, y−h/2), (x−w/2, b+Δ), (x+w/2, b+Δ), (x+w/2, y−h/2)}.

In the third, fourth, or the sixth area, the exposure area P3 is represented as P3={(x−w/2, b−Δ), (x−w/2, y+h/2), (x+w/2, y+h/2), (x+w/2, b−Δ)}.

The control apparatus 28 obtains the information of the outer edge of the valid area set for the wafer, the information of the shot area set for the wafer, and the information of the chip area set inside the shot area. The control apparatus 28 determines whether or not the whole chip area is included in the valid area based on the information. When the whole chip area is not included in the valid area, the control apparatus 28 stops the irradiation of the exposure light by the illumination unit SL so that the whole chip area is not exposed. The control apparatus 28 previously determines whether or not the whole chip area is included in the valid area based on the information of the outer edge of the valid area, the information of the shot area, and the information of the chip area before exposing the wafer W.

The stage control system 21 synchronously controls the acceleration, constant velocity, or deceleration of the wafer stage 1 and the reticle stage 6 at the time of exposure process. In a normal exposure area, the exposure light is irradiated when the wafer stage 1 and the reticle stage 6 are controlled to be a constant velocity. However, the control apparatus 28 stops the irradiation of the exposure light independently from the scanning control of the wafer stage 1 and the reticle stage 6 in the non-exposure area. More specifically, the control apparatus 28 stops the irradiation of the illumination light IL (exposure light) by the illumination unit SL before the deceleration of the wafer stage 1 if the whole chip area is not included in the valid area. Such a control enables the reduction of the cost caused by the wasted irradiation of the exposure light without decreasing the throughput.

According to the present embodiment, the exposable chip area inside the circle outer circumference specified in the partial shot is set as an exposure area. Therefore, the productivity can be improved for the whole wafer.

A device (a semiconductor integrated circuit device, a liquid crystal display device, or the like) is manufactured by a process of exposing a substrate (a wafer, a glass plate, or the like) coated by a photosensitizing agent using the exposure apparatus of one of the above embodiments, a process of developing the substrate, and other well-known processes.

According to each of the above embodiments, an exposure apparatus which efficiently irradiates exposure light can be provided. In particular, the efficient irradiation of the exposure light for the partial shot of the outer circumference of the wafer can be performed. Furthermore, a device manufacturing method using the exposure apparatus can be provided. Therefore, the production cost of a device can be reduced without influencing the throughput.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-152577, filed on Jun. 11, 2008, which is hereby incorporated by reference herein in its entirety.

What is claimed is:

1. An exposure apparatus which has an illumination unit illuminating an original plate and is configured to illuminate a part of the original plate in an illumination area adjusted by the illumination unit to expose a substrate while the original plate and the substrate is scanned, the exposure apparatus comprising:
a controller configured to determine whether or not a whole chip area is included inside a valid area based on information of an outer edge of the valid area set with respect to the substrate, information of a shot area set with respect to the substrate, and information of a chip area set inside the shot area, and configured to stop irradiation of exposure light by the illumination unit so that the whole chip area is not exposed when the whole chip area is not included inside the valid area.

2. An exposure apparatus according to claim 1,
wherein the valid area is an inner area of a concentric circle which has a radius smaller than that of an outer circumference of the substrate.

3. An exposure apparatus according to claim 1,
wherein the controller previously determines whether the whole chip area is included inside the valid area based on the information of the outer edge of the valid area, the information of the shot area, and the information of the chip area before the substrate is exposed.

4. An exposure apparatus according to claim 1,
wherein the controller calculates an irradiation reduction ratio of the exposure light reduced by controlling the illumination unit.

5. An exposure apparatus according to claim 1,
wherein the controller stops the irradiation of the exposure light by the illumination unit before a substrate stage which moves while supporting the substrate is decelerated when the whole chip area is not included inside the valid area.

6. A device manufacturing method comprising the steps of:
exposing a substrate using an exposure apparatus; and
developing the exposed substrate,
wherein the exposure apparatus has an illumination unit illuminating an original plate and is configured to illuminate a part of the original plate in an illumination area adjusted by the illumination unit to expose the substrate while the original plate and the substrate is scanned, and
wherein the exposure apparatus comprises a controller configured to determine whether or not a whole chip area is included inside a valid area based on information of an outer edge of the valid area set with respect to the substrate, information of a shot area set with respect to the substrate, and information of a chip area set inside the shot area, and configured to stop irradiation of exposure light by the illumination unit so that the whole chip area is not exposed if the whole chip area is not included inside the valid area.
